(19) United States
(12) Patent Application Publication
(10) Pub. No.: US 2012/0204827 A1
(43) Pub. Date: Aug. 16, 2012

(54) METHOD, CONTROL UNIT, AND INTERNAL COMBUSTION ENGINE HAVING CYLINDER DEACTIVATION FOR A START-STOP OPERATION HAVING DIRECT START

(76) Inventors: Udo Sieber, Bietigheim (DE); Klaus Ries-Mueller, Bad Rappenau (DE)

(21) Appl. No.: 13/389,481

(22) PCT Filed: Sep. 16, 2010
(86) PCT No.: PCT/EP2010/063631

§ 371 Date: Apr. 20, 2012

(30) Foreign Application Priority Data
Oct. 14, 2009 (DE) 10 2009 045 686.4

(51) Int. Cl. F02D 17/02; F02N 11/08

(52) U.S. Cl. 123/179.4

(57) ABSTRACT

A method for restarting an internal combustion engine with the aid of direct start and cylinder deactivation, a control unit, and such an internal combustion engine are provided, it being possible to switch between a cylinder deactivation mode, in which at least one cylinder of the internal combustion engine is deactivated, and a full count mode, and the internal combustion engine being operatable in an automatic start-stop strategy having subsequent direct start. The method includes an automatic stop, the cylinders which participate in the subsequent direct start are operated without combustion in the cylinder deactivation mode during the previous driving operation.

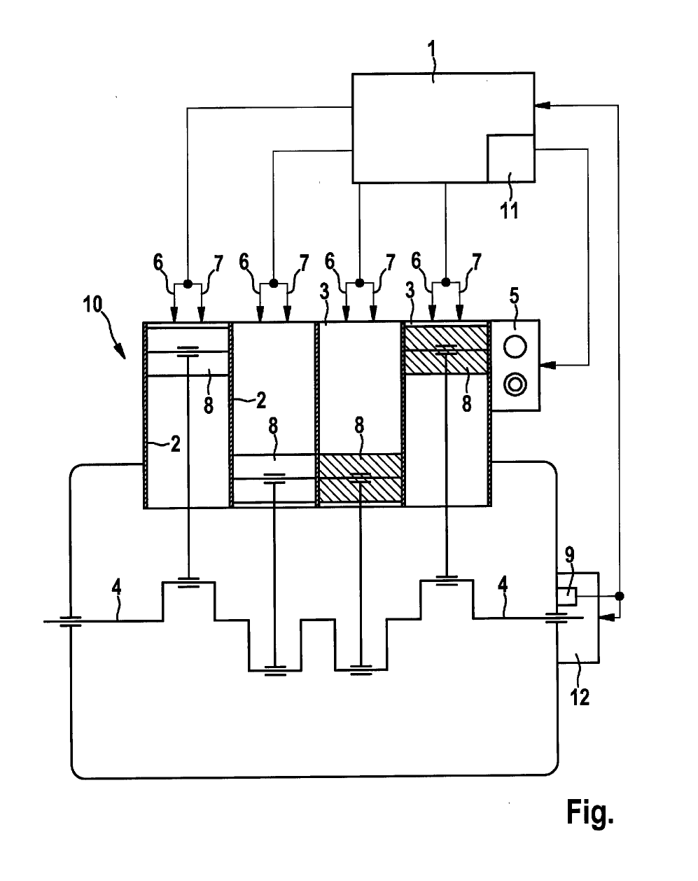

### FIELD OF THE INVENTION

The present invention relates to a method for controlling an internal combustion engine following an automatic stop, a control unit for an internal combustion engine, and an internal combustion engine related thereto having automatic start-stop strategy and the possibility of cylinder deactivation.

### BACKGROUND INFORMATION

Conventionally, internal combustion engines of motor vehicles are operated, for example, to save fuel using a start-stop strategy, in which in the event of a stop at a traffic signal, for example, the internal combustion engine is automatically stopped and is subsequently restarted in the so-called direct start without using a starter. If the driver of a motor vehicle having such an internal combustion engine reactivates the gas pedal after the stop, the engine is automatically started, in particular advantageously without using a starter. In this case, savings in fuel consumption in the magnitude of approximately 5% NEDC (new European driving cycle) are possible. Such start-stop operation is implementable particularly advantageously in the case of gasoline direct injection internal combustion engines, if the direct start may be performed more rapidly and with lower noise than a start using a starter. For such a direct start following an automatic stop, it is necessary for the crankshaft of the internal combustion engine to be located in a favorable position. The cylinders used for the direct start are filled using a fuel-air mixture, which is measured in such a way that an ignition of the mixture alone automatically causes the internal combustion engine to restart.

Conventionally, in addition to start-stop operating modes of this type, engines are used which allow a partial cylinder deactivation for reducing the fuel consumption in motor vehicles. For example, in internal combustion engines having at least four cylinders, two cylinders may be deactivated for a partial-load operation, in order to bring the operating point of the still operated remaining cylinders to a better efficiency level in city traffic at lower load, for example, in order to further reduce the fuel consumption and the emission of pollutants. A cylinder deactivation in internal combustion engines from the related art is performed, for example, by suppressing the injection into some of the cylinders. In addition, there are systems which perform a phase adjustment of the inlet and outlet valves of cylinders, so that as little air as possible flows through the deactivated cylinders. Conventional methods for cylinder deactivation are also used, in which the inlet and outlet valves of some of the cylinders, for example, the cylinders of one bank of an engine, are no longer opened. In this case, the air volume enclosed in the cylinders is used as a type of spring, whereby the deactivated cylinders may still also be moved with relatively low friction during this partial-load operation. Using such systems for partial cylinder deactivation of internal combustion engines, savings in the fuel consumption in the magnitude of 6-8% NEDC may be achieved.

A method and a control unit for restarting an internal combustion engine using such a direct start following an automatic stop of the internal combustion engine are described in German Patent No. DE 103 51 891 A1, a specific quantity of fuel being injected into an intake pipe and the fuel-air mixture enclosed in a combustion chamber of the cylinder being ignited to restart the internal combustion engine, as long as the mixture is still ignitable.

### SUMMARY

An example method according to the present invention for restarting an internal combustion engine having multiple, partially deactivatable cylinders and in particular an internal combustion engine having gasoline direct injection allow switching back and forth between a cylinder deactivation mode, in which at least one cylinder of the internal combustion engine is deactivated, and a full number mode, in which no cylinders are deactivated, and operating the internal combustion engine in an automatic start-stop strategy having subsequent direct start. In the method, following an automatic stop, the cylinders participating in the subsequent direct start are operated in a targeted manner without combustion in the cylinder deactivation mode during the previous driving operation. In this way, according to the example embodiment of present invention, the cylinder combustion chamber temperature of the cylinders participating in a direct start is reduced in a targeted manner, in that the cylinders are not fired intentionally during the previous operation of the internal combustion engine, i.e., these cylinders are operated in a deactivated manner as a result of the cylinder deactivation. The starting reliability during the direct start is significantly improved by the lower temperature. The lower temperature results in a higher level of cylinder filling and therefore in a higher oxygen content in the cylinder(s) used for the direct start. Since, according to the example embodiment of the present invention, the cylinders of an internal combustion engine, in particular of a gasoline engine having gasoline direct injection, which participate in the direct start, were operated in the cylinder deactivation mode during the previous driving operation without combustion, i.e., without being fired, the temperature in the combustion chambers of these cylinders is automatically reduced in relation to that of fired cylinders. The starting reliability is increased in this way, the combustion of the cylinders participating in the direct start is improved, a greater starting force is generated, and the fuel consumption as well as the pollutant emissions are accordingly further reduced.

According to one advantageous embodiment of the method according to the present invention, the cylinders participating in the direct start were operated without injection during the previous driving operation, i.e., before an automatic stop by the start-stop strategy. The suppression of the injection of the cylinders which are not operated in the cylinder deactivation mode may be implemented using relatively simple means. Alternatively or additionally, the cylinder deactivation for the method according to the present invention may also be performed by a phase adjustment of the inlet and/or outlet valves. Additionally or alternatively, the deactivation of the cylinders for the partial-load operation may be carried out before an automatic stop and prior to the subsequent direct start of the internal combustion engine by completely closing individual inlet and/or outlet valves of the particular cylinders. Each of these alternatives has the advantage that the intentional and targeted cylinder deactivation during a partial-load operation is used for the purpose of achieving an advantageous reduction of the combustion chamber temperature in the cylinders which are used for the rapid and low-noise direct start. Since no combustion occurs during the previous driving operation in these cylinders, the combustion chamber temperature has efficiently been reduced to a lower level using relatively simple means. The starting reliability during the direct start is significantly improved in this way.

According to another advantageous embodiment of the present invention, positioning of a crankshaft in the internal combustion engine is performed prior to the direct start in such a way that the cylinder or cylinders which were not fired or ignited during the previous driving operation are used for a direct start following an automatic stop. In this way, the most favorable position of the crankshaft may be achieved, in particular as a function of the position of cylinders and their pistons which were previously operated in the cylinder deactivation mode, for the subsequent direct start following an automatic stop of the internal combustion engine. The most favorable position of the crankshaft in accordance with the cylinders used for the direct start further improves the starting reliability solely by igniting these cylinders. The possibility of selecting cylinders used for the direct start after the stop is therefore increased.

According to respective alternative of the method according to the present invention, positioning of the crankshaft prior to the direct start or during an engine rundown following an automatic stop is performed either by activating a throttle valve during the engine rundown, by changing a generator torque during the engine rundown, by activating and deactivating ancillary units to position the crankshaft during the engine rundown, or by using an engine starter to position the crankshaft after the engine rundown or shortly before the direct start. Using these measures, which are used according to the present invention both individually and also in combination with one another to implement the method, the best possible positioning of the crankshaft for the direct start using the selected, previously unfired cylinders may be carried out in a relatively simple manner. The piston of the cylinder used for the direct start may be set during a power stroke or in a position shortly after a top dead center in a targeted manner, for example.

According to another advantageous embodiment of the method according to the present invention, a cooling system of the internal combustion engine is provided, which is adapted to cool the cylinders which are no longer fired during partial-load operation and are used for the subsequent direct start to a greater extent than the remaining cylinders, in order to achieve a further targeted reduction of the combustion chamber temperature of these cylinders at the point in time of the direct start, even in the case of short stops. Through the targeted stronger cooling of the cylinders used for the direct start, their combustion chamber temperature is further reduced, the cylinder filling is thus further increased, and the combustion of these individual cylinders used for the direct start is perfectly optimized. In this way, the starting reliability during the direct start of the internal combustion engine is also further improved, since a higher starting torque is generated by this cylinder or these cylinders.

According to another advantageous embodiment of the method according to the present invention, positioning of the crankshaft in the internal combustion engine is performed, in the case in which the cylinders operated without combustion during the previous driving operation are not immediately in the ignition sequence for the automatic stop, in such a way that during the direct start only in the forward direction the cylinder being in the compression stroke at the beginning of the start was not fired. The method according to the present invention may therefore respect the predetermined ignition sequence of the internal combustion engine and nonetheless advantageously reduce the combustion chamber temperature in a targeted manner in the cylinder used for the direct start.

According to another advantageous embodiment of the method according to the present invention, prior to a direct start and following an automatic stop by the start-stop strategy, an initial rotational direction reversal of the crankshaft is performed in such a way that the cylinder that is first in the power stroke was not fired before the stop during the previous driving operation. This increases the selection possibility of the cylinders which are usable for a direct start and are therefore reduced in the combustion chamber temperature in a targeted manner. The usage possibilities of the method are therefore more variable even in the case of a relatively small number of cylinders (for example, in the case of engines having only four cylinders).

According to the present invention, an example control unit for an internal combustion engine, which has multiple, partially deactivatable cylinders and is operated in an automatic start-stop strategy having subsequent direct start after a stop, is provided in particular for carrying out the described example method, the control unit being characterized in that it can operate the cylinders participating in the direct start without combustion, i.e., unfired, in the cylinder deactivation mode during the previous driving operation before the stop. Using the control unit, in existing internal combustion engines having a cylinder deactivation mode, the temperature may be reduced in a targeted manner in the combustion chamber or chambers of the cylinders which are used for a direct start without starter following an automatic stop. By reducing the temperature in the cylinder combustion chamber, the cylinder filling and therefore the oxygen content in the fuel-air mixture in the cylinder is increased, which improves the subsequent combustion used for the direct start. The control unit therefore increases the starting reliability for a direct start. The control unit may be integrated as a control module in an existing electronic engine controller of a motor vehicle, for example. The control unit may also be stored in the form of a computer program on a data medium and integrated in program form in an engine controller of the internal combustion engine.

According to one alternative embodiment of the control unit according to the present invention, sensors are provided for detecting the position of a crankshaft, and the control unit is adapted to carry out targeted positioning of the crankshaft prior to the direct start in such a way that only cylinders which were not fired during the previous driving operation are used for the direct start. By detecting and repositioning the crankshaft, reliable starts following an automatic stop are also possible without a starter, even if the cylinders operated in the cylinder deactivation mode during the previous driving operation are not located in an optimum position following the engine rundown. The sensor detects the position of the crankshaft and therefore the particular stroke of the cylinders to be used for the direct start and sets the crankshaft in such a way that the cylinders are located in an optimum position for a direct start.

The present invention also relates to an internal combustion engine having a cylinder deactivation mode, which is adapted for an automatic start-stop operation having subsequent direct start following an automatic stop, the internal combustion engine being characterized in that it has a control unit according to the present invention, in order to be operated according to the described method according to the present invention. According to one alternative embodiment of the present invention, the internal combustion engine may have a control module for controlling an engine cooling system for this purpose, which is adapted to cool cylinders participating in a direct start, in a targeted manner, to a greater extent than the other cylinders, following an automatic stop. With the aid of this measure, a further reduction of the combustion chamber temperature in the cylinders to be used for the direct start is possible. The filling of the cylinder is therefore increased and ignition and combustion are improved, whereby a direct start without falling back on a separate engine starter is possible even in the case of otherwise unfavorable starting situations.

### BRIEF DESCRIPTION OF THE DRAWING

An exemplary embodiment of the present invention is described in greater detail below with reference to the FIGURE.

The FIGURE shows schematically an internal combustion engine, which is operated according to one exemplary embodiment of the method according to the present invention, having four cylinders.

### DETAILED DESCRIPTION OF EXAMPLE EMBODIMENTS

The exemplary embodiment of the present invention, which is schematically shown in the FIGURE, is an internal combustion engine 10 having four cylinders 2, 3. Internal combustion engine 10 is provided with a cylinder deactivation, via which at least one cylinder 3 of the internal combustion engine may be deactivated in partial-load operation. In the FIGURE, deactivatable cylinders 3 are shown having shaded pistons 8, while non-deactivatable cylinders 2 of internal combustion engine 10 are shown without shading. Internal combustion engine 10 according to this exemplary embodiment also has a control unit 1, which may be implemented as an electronic engine controller. The engine may be operated in a so-called automatic start-stop strategy with the aid of control unit 1, in which in the event of a stop of a motor vehicle at a traffic signal, for example, the internal combustion engine is automatically stopped and subsequently restarted in the form of a direct start when the driver operates a gas pedal, for example. In the case of the direct start following an automatic stop and a shutdown of internal combustion engine 10, internal combustion engine 10 is started without using a starter of the motor vehicle by employing at least some of the cylinders and a fuel-air mixture enclosed therein, which is ignited in a targeted manner. The direct start is characterized by a comparatively rapid and low-noise start. The start-stop strategy, using which internal combustion engine 10 according to the present invention is operated, has the advantage, as does the cylinder deactivation during partial-load operation, of substantial fuel savings, in particular in city traffic, and a reduction of pollutant emissions.

According to an example embodiment of the present invention, internal combustion engine 10 is operated using a special method for restarting with the aid of a direct start, taking into account the cylinder deactivation of internal combustion engine 10. Following an automatic stop as a result of the start-stop strategy, which is controlled by control unit 1, only cylinders 3, which were operated during the previous driving operation of internal combustion engine 10 and therefore of the vehicle without combustion, i.e., unfired, in the cylinder deactivation mode, are used for the subsequent direct start. For this purpose, control unit 1 receives information regarding which cylinders 2, 3 were fired during driving operation and which were only moved along without ignition. By using cylinders 3 which did not participate during the previous driving operation for the direct start, the combustion chamber temperature in these cylinders 3 is reduced, which has the advantage that better filling with fuel-air mixture of cylinder 3 or cylinders 3 to be used for the direct start is possible and thus a more reliable direct start is ensured even in the case of less favorable conditions. For the cylinder deactivation of cylinders 3 during driving operation (partial-load operation), the injection into the cylinders may, on the one hand, be deactivated or suppressed according to the present invention. In addition, inlet and outlet valves may also be provided with an arrangement for phase adjustment for the cylinder deactivation. Or, the inlet and/or outlet valves are completely closed to deactivate individual cylinders 3. A requirement for a cylinder deactivation is the presence of at least four cylinders 2, 3, as is the case in the example shown in the FIGURE. Of course, multi-cylinder engines and in particular engines having six, eight, or twelve cylinders may also be used to carry out the method according to the present invention. Special advantages and even greater savings potentials also result here due to the synergy according to the present invention between the cylinder deactivation and the start-stop operation.

A final control element 12 using which the position of the crankshaft and therefore the position of cylinders 2, 3 in internal combustion engine 10 may be set in a targeted manner is also provided on the side of crankshaft 4 in the exemplary embodiment shown in the FIGURE. A sensor 9 for detecting a crankshaft position of crankshaft 4 is also provided, so that control unit 1 receives the required information to establish which cylinder 3, which was previously not fired during driving operation, may be used for the direct start following an automatic stop. Control unit 1 initiates the injection of fuel into the combustion chamber via injector 6 and the firing via an ignition 7 of the cylinders in this cylinder 3 or these cylinders 3, in order to drive crankshaft 4 and start internal combustion engine 10 in this way, without the need for using an external starter of the engine for this purpose. The positioning of crankshaft 4 for a favorable position of previously unfired cylinder 3 for a direct start may be performed using a final control element 12, as is schematically shown in the example of the FIGURE of the drawing. Alternatively or additionally, the targeted setting of the position of crankshaft 4 may also be carried out by activating a throttle valve of internal combustion engine 10 during the engine rundown following an automatic stop. Other possibilities for positioning crankshaft 4 are to change the generator torque during the engine rundown, to activate and/or deactivate other ancillary units such as an air conditioner of a motor vehicle or a similar unit for positioning during the rundown, and to use the starter of internal combustion engine 10 to position crankshaft 4 after the engine rundown or shortly prior to the direct start according to the present invention.

When positioning crankshaft 4, the position of crankshaft 4 is preferably set via final control element 12 and control unit 1 in such a way that cylinder 3 or its piston 8 is located in a favorable position, which is to be used for the direct start and was previously not fired. For this purpose, cylinder 3 is positioned during a power stroke, for example, which may be used efficiently and have maximum starting torque for the subsequent direct start. Positioning of crankshaft 4 with the aid of final control element 12 may also be carried out using an initial reversal of the direction of rotation shortly before a beginning of the start, in order to reach the most favorable position of cylinder 3 used for the direct start.

In the exemplary embodiment shown in the FIGURE, a cooling system 5, which is schematically shown here having a supply line and a feedback line, is also provided for cooling cylinders 2, 3. Cooling system 5 is coupled to control unit 1 and to a special control module 11, located therein, for controlling cooling system 5. Cooling system 5 and corresponding control module 11 are adapted according to the present invention in such a way that cylinders 3 to be used for a subsequent direct start, which were not previously fired during driving operation, may be cooled to a greater extent than other cylinders 2 in internal combustion engine 10. A further intentional reduction of the combustion chamber temperature is achieved in this way, thus making even better filling of this cylinder 3 with a fuel-air mixture possible, thus resulting in a reliable start of internal combustion engine 10 via a so-called direct start, even in situations which are normally critical for this purpose, and in engine rundown positions.

1-11. (canceled)

12. A method for restarting an internal combustion engine having multiple, partially deactivatable cylinders, the internal combustion engine having gasoline direct injection for a motor vehicle, the method comprising:
switching between a cylinder deactivation mode, in which at least one cylinder of the internal combustion engine is deactivated, and a full count mode;
operating the internal combustion engine in an automatic start-stop strategy having subsequent direct start; and
after a stop in the start-stop strategy, operating cylinders participating in the subsequent direct start during a previous driving operation without combustion in the cylinder deactivation mode of the internal combustion engine.

13. The method as recited in claim 12, wherein the cylinders participating in the direct start are operated without injection during the previous driving operation.

14. The method as recited in claim 12, wherein positioning of a crankshaft is performed prior to the direct start in such a way that cylinders which were unfired during the previous driving operation are used for the direct start.

15. The method as recited in claim 14, wherein the positioning of the crankshaft is carried out by one of activating a throttle valve during engine rundown, changing a generator torque during the engine rundown, activating and deactivating ancillary units for positioning during the engine rundown, or using an engine starter to position the crankshaft after the engine rundown or shortly prior to the direct start.

16. The method as recited in claim 12, further comprising:
cooling, using a cooling system of the internal combustion engine, to cool the cylinders, which are no longer fired during a partial-load operation and are used for the direct start, to a greater extent in order to achieve a predefined reduction of the combustion chamber temperature of the cylinders at a point in time of the direct start.

17. The method as recited in claim 12, further comprising:
positioning the crankshaft in such a way that cylinders operated without combustion in a previous driving operation are fired for a subsequent direct start.

18. The method as recited in claim 12, wherein, prior to the direct start, an initial reversal of a direction of rotation of the crankshaft is performed, so that the cylinder of the internal combustion engine which is first in a power stroke was fired during driving operation before the stop.

19. A control unit for an internal combustion engine having multiple, partially deactivatable cylinders, the internal combustion engine being for a motor vehicle and having gasoline direct injection, which is operated in an automatic start-stop strategy having subsequent direct start following an automatic stop, the control unit comprising:
an arrangement adapted to operate cylinders participating in the direct start in an unfired manner during a previous driving operation before a stop.

20. The control unit as recited in claim 19, wherein sensors are provided for detecting a position of a crankshaft of the internal combustion engine, and the control unit being configured to execute targeted positioning of a crankshaft prior to the direct start in such a way that only cylinders which were not fired during the previous driving operation are used for the direct start.

21. An internal combustion engine for a motor vehicle having gasoline direct injection, comprising multiple partially deactivatable cylinders, which is adapted to be operated in an automatic start-stop strategy having subsequent direct start following an automatic stop, and a control unit configured to operate cylinders participating in the direct start in an unfired manner during a previous driving operation before a stop.

22. The internal combustion engine as recited in claim 21, further comprising:
a control module to control an engine cooling system, cylinders participating in a direct start following an automatic stop after the driving operation are coolable to a greater extent in a targeted manner with the aid of the control module.
